(19) United States
(12) Patent Application Publication
(10) Pub. No.: US 2020/0156211 A1
(43) Pub. Date: May 21, 2020

(54) METHOD AND SYSTEM FOR CONTROLLING POLISHING AND GRINDING

(71) Applicant: Industrial Technology Research Institute, Hsinchu (TW)

(72) Inventors: Cheng-Peng Kuan, Hsinchu (TW); Chih-Hsuan Shih, Hsinchu (TW); Kuo-Feng Hung, Hsinchu (TW); Yen-Chung Chang, Hsinchu (TW); Hung-Hsiu Yu, Hsinchu (TW)

(21) Appl. No.: 16/233,859

(22) Filed: Dec. 27, 2018

(30) Foreign Application Priority Data
Nov. 15, 2018 (TW) 107140671

(51) Int. Cl. B24B 51/00; B25J 11/00; B24B 21/16; B24B 49/00

(52) U.S. Cl. CPC B24B 51/00; B24B 49/003; B24B 21/16; B25J 11/0065

(57) ABSTRACT

A method for controlling polishing and grinding is provided, including: generating an initial polishing and grinding trajectory for robot movements based on a three-dimensional contour of a work piece; adjusting the initial polishing and grinding trajectory based on a first optimized adjustment value and generating an optimized polishing and grinding trajectory; and evaluating the polishing and grinding quality of the work piece and using the polishing and grinding quality to generate a second optimized adjustment value.

### CROSS-REFERENCE TO RELATED APPLICATIONS

This application claims priority to Taiwanese Application Serial No. 107140671, filed on Nov. 15, 2018. The entirety of the above-mentioned patent application is hereby incorporated by reference herein and made a part of this specification.

### BACKGROUND

### 1. Technical Field

This disclosure relates to polishing and grinding techniques, and, more particularly, to a method and a system for controlling polishing and grinding, applicable to a robot clamping a work piece and polishing and grinding the work piece.

### 2. Description of Related Art

In the sanitary ware, vehicle parts and construction hardware industries, most metal work pieces need to be polished or ground in order to clean burr in the edge or make the metal work piece more polished to be electroplated more easily. Currently, the metal work piece is polished and ground manually. In such a scenario, the metal work piece cannot be polished and ground quickly, the environment where the polishing and grinding operations are performed is terrible, and the polished and ground metal work pieces cannot have consistent quality, which are contradictory to the mass production requirement.

In recent years, robots are developed very rapidly, and many industries introduce robots to replace labors. Therefore, the convention manufacturing technique of polishing and grinding work pieces manually are replaced by automatic robots gradually. When a robot polishes and grinds a work piece, a trajectory along which the robot moves has a direct effect on a contact state of the work piece with a surface of an abrasive belt, and, as such, affects the machining precision and the quality of the surface of the work piece.

The modern robot controlling system has to be installed with a plurality of different programs to address a variety of polishing and grinding trajectories of a plurality of work pieces that have different shapes and contours. A work piece has its own dedicated polishing and grinding trajectory. As a different work piece needs to be polished and ground, a new program has to be written to address the shape and contour of the work piece. Moreover, the original installation of the polishing and grinding apparatus is likely changed due to human or environment factors (e.g., an earthquake may change the relative position of the robot or the polishing and grinding apparatus). Since a slight offset of the apparatus may make a significant effect on the polishing and grinding precision of the work piece, a great amount of time and efforts have to be spent in readjusting the installation parameters of the apparatus or rewriting the program to adjust the polishing and grinding trajectory of the robot, in order to maintain the original polishing and grinding quality of the work piece.

Therefore, how to solve the problems of the prior art that the existing polishing and grinding system cannot address the variation of the work pieces or the hardware apparatus and adjust the polishing and grinding trajectory to maintain the optimization of the polishing and grinding quality is becoming an urgent issue in the art.

### SUMMARY

In an embodiment according to the present disclosure, a method for controlling polishing and grinding is provided, including: generating an initial polishing and grinding trajectory for robot movements based on a three-dimensional contour of a work piece; adjusting the initial polishing and grinding trajectory based on a first optimized adjustment value to generate an optimized polishing and grinding trajectory; and evaluating if polishing and grinding quality of the work piece is better than polishing and grinding quality of a last work piece, and, if so, generating a second optimized adjustment value in place of the first optimized adjustment value.

In another embodiment according to the present disclosure, a system for controlling polishing and grinding is also provided, including: a trajectory generating module configured for generating an initial polishing and grinding trajectory for robot movements based on a three-dimensional contour of a work piece; a trajectory optimizing module configured for adjusting the initial polishing and grinding trajectory based on a first optimized adjustment value; and a quality evaluating module configured for evaluating if polishing and grinding quality of the work piece is better than polishing and grinding quality of a last work piece, and, if so, generating a second optimized adjustment value in place of the first optimized adjustment value.

It is known from the above that a method and a system for controlling polishing and grinding according to the present disclosure may use an artificial intelligent learning method to update polishing and grinding data automatically in order to employ a polishing and grinding trajectory that is optimized. In an embodiment, a portion of contours of a variety of work pieces and optimal polishing and grinding trajectories corresponding to the portion of the contours are stored in a database. Therefore, as a plurality of work pieces to be polished and ground have different shapes, corresponding polishing and grinding trajectories of the work pieces can be generated automatically. The problem of the prior art that the conventional polishing and grinding apparatus cannot automatically adjust polishing and grinding trajectories to maintain the best quality can be solved.

### BRIEF DESCRIPTION OF DRAWINGS

The disclosure can be more fully understood by reading the following detailed description of the preferred embodiments, with reference made to the accompanying drawings, wherein:

FIG. 1 is a functional block diagram of a system for controlling polishing and grinding according to the present disclosure;

FIG. 2 is a schematic diagram of a polishing and grinding hardware apparatus to which the system for controlling polishing and grinding according to the present disclosure is applied;

FIG. 3 is a curve diagram of reading data of a force sensor; and

FIG. 4 is a flow chart of a method for controlling polishing and grinding according to the present disclosure.

### DETAILED DESCRIPTION

It will be readily understood that the devices and methods of the present disclosure, as generally described and illustrated in the drawings herein, may be arranged and designed in a wide variety of different configurations in addition to the devices and methods described herein. Thus, the following detailed description of the devices and methods, as represented in the drawings, is not intended to limit the scope defined by the appended claims but is merely representative of selected devices and methods. The following description is intended only by way of example, and simply illustrates certain concepts of the devices and methods, as disclosed and claimed herein.

The terminology used herein is for the purpose of describing particular devices and methods only and is not intended to be limiting of this disclosure. As used herein, the singular forms “a”, “an”, and “the” are intended to include the plural forms as well, unless the context clearly indicates otherwise. It will be further understood that the terms “comprises”, “comprising”, “includes”, and “including”, when used in this specification, specify the presence of stated features, integers, steps, operations, elements, and/or components, but do not preclude the presence or addition of one or more other features, integers, steps, operations, elements, components, and/or groups thereof.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements).

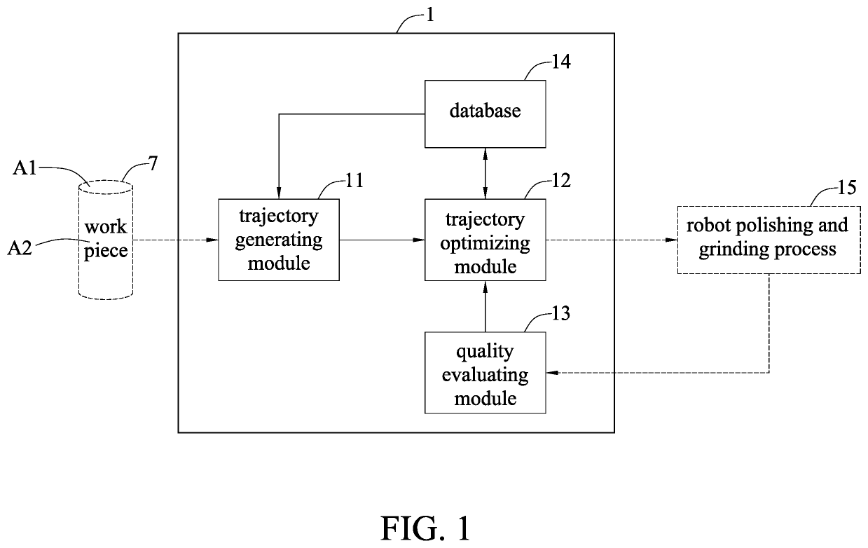

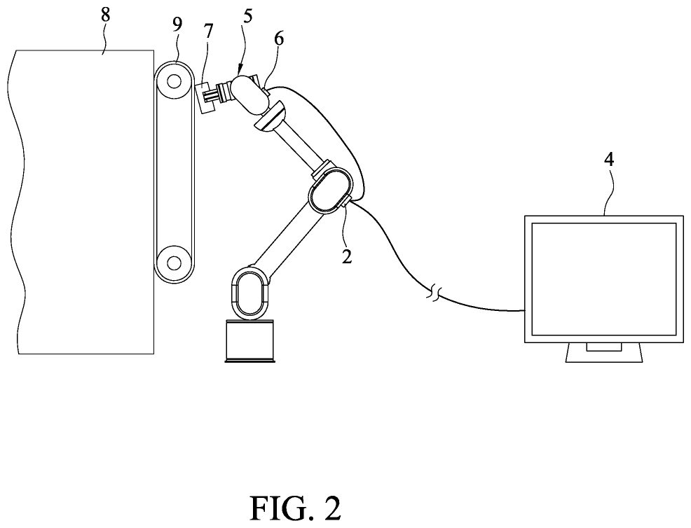

FIG. 1 is a functional block diagram of a system for controlling polishing and grinding 1 according to the present disclosure. FIG. 2 is a schematic diagram of a polishing and grinding hardware apparatus to which the system for controlling polishing and grinding 1 according to the present disclosure is applied.

In an embodiment, the system for controlling polishing and grinding 1 is installed in a computer 4 connected to a robot driver 2 and a sensing device 6. The computer 4 issues a control signal to the robot driver 2 to perform a robot polishing and grinding process 15. The robot driver 2 issues a real-time trajectory message of the robot 5 to the computer 4. In an embodiment, the sensing device 6 connected to the robot 5 is a force sensor, an acoustic emission sensor (AE sensor) or an inertial measurement unit sensor (IMU sensor). The force sensor collects a force-related message during the exercise period of the robot 5. The acoustic emission sensor detects an acoustic signal inside a material or a structure. The inertial measurement unit sensor detects data, such as velocity and orientation, during the exercise period of the robot 5. The sensing device 6 sends its own sensing signal to the computer 4, for the system for controlling polishing and grinding 1 to analyze data, and adjust an exercise trajectory of the robot 5 and apply a most suitable polishing and grinding force based on the analysis result, to optimize polishing and grinding quality of a work piece 7.

In an embodiment, the system for controlling polishing and grinding 1 comprises a trajectory generating module 11, a trajectory optimizing module 12, a quality evaluating module 13 and a database 14. The database 14 is configured for storing contour data and polishing and grinding data of a work piece. The trajectory generating module 11 generates an initial polishing and grinding trajectory for robot movements based on a three-dimensional contour of the work piece 7 and the polishing and grinding data. The trajectory optimizing module 12 adjusts the initial polishing and grinding trajectory based on a first optimized adjustment value to generate an optimized polishing and grinding trajectory. The quality evaluating module 13 evaluates the polishing and grinding quality of the work piece. In an embodiment, the quality evaluating module 13 generates a second optimized adjustment value in place of the first optimized adjustment value when evaluating that the polishing and grinding quality is better than polishing and grinding quality of a last work piece, and stores the second optimized adjustment in the database 14.

How the trajectory generating module 11 generates the initial polishing and grinding trajectory based on the three-dimensional contour of the work piece 7 is described in the following paragraphs.

In an embodiment, the work piece 7 is a metal work piece that has a three-dimensional design figure corresponding to its contour when it is cast. Before the work piece 7 is polished and ground by the system for controlling polishing and grinding 1 according to the present disclosure, the three-dimensional design figure is input to the trajectory generating module 11 directly, and the trajectory generating module 11 searches the database 14 for an initial polishing and grinding trajectory that has the same shape of the work piece 7 as a whole and corresponds to the contour of the work piece 7. Alternatively, a three-dimensional contour of the work piece 7 can be obtained by 3D laser scanning and input to the trajectory generating module 11 before the work piece 7 is conducted in the robot polishing and grinding process 15. In an embodiment, the database 14 is configured for storing polishing and grinding data of a portion of contours of a plurality of last work pieces, and the trajectory generating module 11 searches the database 14 for polishing and grinding data corresponding to the portion of the contours of the plurality of work pieces and combines the polishing and grinding data to generate an initial polishing and grinding trajectory of the work piece 7 that is going to be polished and ground. In an embodiment, the system for controlling polishing and grinding 1 according to the present disclosure can separate contours of different parts (e.g., a flat plane and a curved plane) of the work piece after being polished and ground from one another, and store the contour data of the parts and polishing and grinding trajectory corresponding thereto in the database 14. Therefore, as a next work piece 7 is going to be polished and ground, the trajectory generating module 11 can obtain from the database 14 polishing and grinding trajectories corresponding to the contours of the work piece 7, and combine the polishing and grinding trajectories to become an initial polishing and grinding trajectory of the next work piece 7.

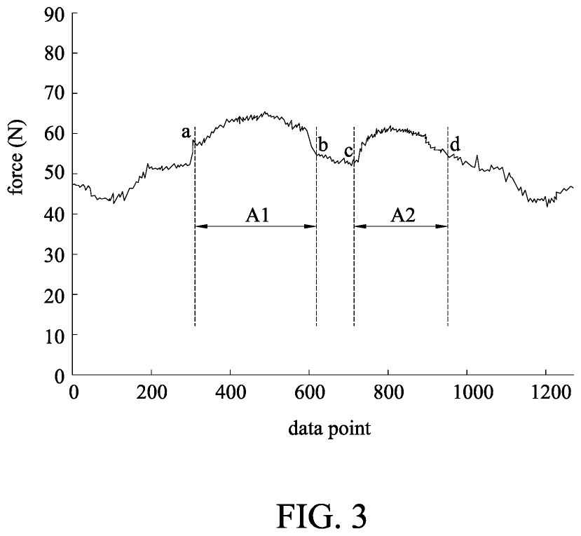

In an embodiment, a polishing and grinding dataset can be established in the database 14 for a subsequent polishing and grinding operation. In another embodiment, the system for controlling polishing and grinding 1 may establish force sensing data corresponding to polishing and grinding trajectories during a polishing and grinding process of a plurality of last work pieces 7. Please refer to FIG. 3, which is a curve diagram of data read by a force sensor during a polishing and grinding process of the work piece 7, wherein A1 contours and A2 contours constitute a surface of the work piece 7 and the force sensor reads a force sensing data point every 0.1 second. In the data curve shown in FIG. 3, point a corresponds to a force sensing value of the surfaces of A1 contours of the work piece 7 being in contact with an abrasive belt 9 to start the polishing and grinding, point b corresponds to a force sensing value of the surface of A1 contours leaving the abrasive belt 9 to end the polishing and grinding, point c corresponds to a force sensing value of the surfaces of A2 contours of the work piece 7 being in contact with an abrasive belt 9 to start the polishing and grinding, and point d corresponds to a force sensing value of the surface of A2 contours leaving the abrasive belt 9 to end the polishing and grinding. The exercise trajectory data sent by the robot driver 2 during the polishing and grinding process and the sensing data sent by the force sensor can be simultaneously stored in the polishing and grinding data corresponding to the A1 contours and the A2 contours. In an embodiment, the system for controlling polishing and grinding 1 according to the present disclosure, if having completed the polishing and grinding operations of the work piece 7 (including, for example, the A1 contours and the A2 contours) and the work piece 7′ (including, for example, the B1 contours, the B2 contours and the B3 contours), will store the A1 contours, the A2 contours, the B1 contours, the B2 contours and the B3 contours and the A1 trajectory, the A2 trajectory, the B1 trajectory, the B2 trajectory and the B3 trajectory for polishing and grinding the contours into the database 14. When a next work piece 7″ is going to be polished and ground, the trajectory generating module 11 first determines the constitution of the contours of the work pieces 7″ (e.g., the work piece 7″ is constituted by the A1 contours and the B3 contours), then acquires from the database 14 the A1 contours corresponding to the work piece 7, the B3 contours corresponding to the work piece 7′, and the A1 trajectory and the B3 trajectory corresponding to the A1 contours and the B3 contours, respectively, and combines the A1 trajectory and the B3 trajectory to become an initial polishing and grinding trajectory of the work piece 7″.

In an embodiment, the quality evaluating module 13 is configured for evaluating polishing and grinding quality of the work piece, and the polishing and grinding quality is used for generating an optimized adjustment value in place of a last optimized adjustment value.

In an embodiment, the system for controlling polishing and grinding 1 according to the present disclosure can mark the polishing and grinding quality after completing the polishing and grinding operation of the work piece 7. In another embodiment, a surface characteristic measuring apparatus, such as a contact roughness measuring instrument, an atomic force microscope, a white light interferometry and a laser microscope, is used to measure the surface roughness or reflection rate of the work piece as a basis of the determination of quality evaluation. In yet another embodiment, an audio frequency value sensed by an audio frequency sensor during a polishing and grinding process can be used to evaluate quality. In still another embodiment, when the work piece 7 is in contact with the surface of the abrasive belt 9, it is predicted that better polishing and grinding quality is obtained if the audio frequency is within a predetermined range. In an embodiment, the surface roughness and reflection rate of the work piece 7 after being polished and ground can also be determined manually to make a quality mark. In another embodiment, a quality mark Q1 represents “excellent,” a quality mark Q2 represents “mediocre,” and a quality mark Q3 represents “bad.” The quality mark Q1, Q2 or Q3 of the work piece, the sensing data, such as a force reading value from a force sensor (relating the set polishing and grinding force) and positions and directions read by an inertial measurement unit sensor during a polishing and grinding process, and the contours and the polishing and grinding trajectory of the work piece are input to the database 14 to form a training dataset. Further, data of the work piece 7 at any time point during a polishing and grinding process, including contours, polishing and grinding forces, trajectories, directions and positions that can form state data S, can also be stored in the database 14. In an embodiment, the state data S1, S2, S3 and S4 of a plurality of work pieces and data points (S1, Q1), (S2, Q3), (S3, Q2), (S4, Q2) . . . formed by the quality mark Q1, Q2 or Q3 constitute the training set and can be stored in the database 14.

In an embodiment, how the trajectory optimizing module 12 adjusts the initial polishing and grinding trajectory based on an optimized adjustment value to generate an optimized polishing and grinding trajectory is described in the following paragraphs.

In an embodiment, the trajectory optimizing module 12 includes a machine learning function of a neural network. The neural network can calculate and learn the relation among the data points (S1, Q1), (S2, Q3), (S3, Q2), (S4, Q2) . . . of the training dataset based on an optimization program. The state data corresponding to the optimal polishing and grinding quality can be updated by a machine learning of a great number of data points. The state data corresponding to the optimal quality (e.g., the state data S1 corresponding to the quality mark Q1) is stored in the database 14 to be used in the polishing and grinding operation of a next work piece. After the trajectory optimizing module 12 infers the state data S1 corresponding to the optimal quality Q1 inversely from the data via a learning algorithm, the polishing and grinding forces and trajectories set then can be obtained from the constitution of the state data S1, and a difference between the polishing and grinding trajectory and a polishing and grinding trajectory of the last optimal quality can be calculated as an optimized adjustment value of the trajectory of a next work piece 7 that is going to be polished and ground. The contact force of the work piece 7 when propping against the abrasive belt 9 relates to a feed rate of the robot 5 moving along a normal direction of a surface of the abrasive belt 9, and the controlling of the amount and direction of the contact force affects the polishing and grinding quality of the surface of the work piece 7 directly. As shown in FIG. 3, the feed rate of the robot 5 moving and clamping the work piece 7 and the angle of the work piece 7 in contact with the abrasive belt 9 during point a to point b and point c to point d can be controlled, in order to control the polishing and grinding conditions of the work piece 7 precisely.

According to the present disclosure, the surface quality of the abrasive belt 9 can be further determined based on the variation of the optimized adjustment value. In an embodiment, the learning function of the trajectory optimizing module 12 can update polishing and grinding data gradually and calculate an trajectory optimized adjustment value to maintain the best quality used for adjusting the polishing and grinding trajectory of a next work piece 7. However, the surface roughness of the abrasive belt 9 will be degraded every time the abrasive belt 9 is used. As the optimized adjustment value (e.g., the first optimized adjustment value) that is used to adjust the initial polishing and grinding trajectory of the work piece 7 increases gradually and is greater than a threshold, or as the polishing and grinding trajectories needed by different work pieces having the same contours differ from one another significantly, which indicates that the adjustment of the polishing and grinding trajectories does not make a significant effect on the optimization of the quality, it is predicted that the quality of the abrasive belt 9 is less than a predetermined surface roughness. In such a scenario, it is the abrasive belt 9 that should be replaced with a new one, and there is no need to adjust the polishing and grinding trajectory of the abrasive belt 9.

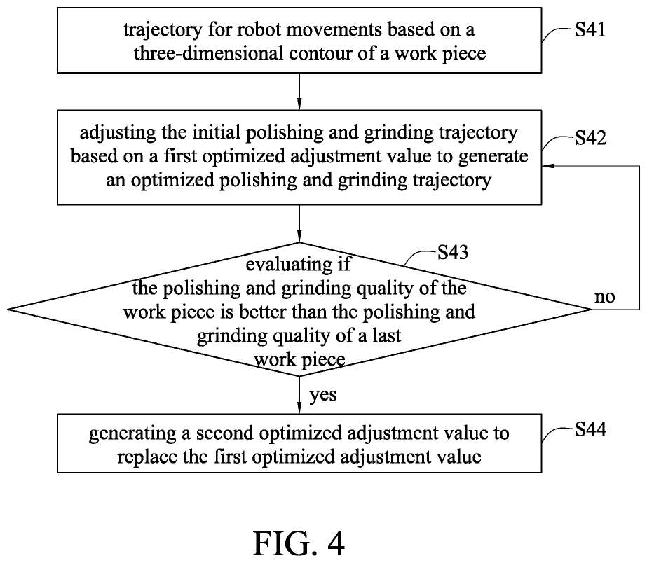

Please refer to FIG. 4, which is a flow chart of a method for controlling polishing and grinding according to the present disclosure. In step S41, the trajectory generating module 11 generates an initial polishing and grinding trajectory for robot movements based on a three-dimensional contour of a work piece 7 stored in a database 14. In step S42, the trajectory optimizing module 12 adjusts the initial polishing and grinding trajectory based on a first optimized adjustment value to generate an optimized polishing and grinding trajectory. In step S43, the quality evaluating module 13 evaluates if the polishing and grinding quality of the work piece is better than the polishing and grinding quality of a last wok piece. In step S44, if the polishing and grinding quality is better than the polishing and grinding quality of the work piece, a second optimized adjustment value is generated to replace the first optimized adjustment value. If the polishing and grinding quality is not better than the polishing and grinding quality of the work piece, the method returns to step S42 to adjust the initial polishing and grinding trajectory based on the first optimized adjustment value to generate the optimized polishing and grinding trajectory. In an embodiment, the polishing and grinding data of the work piece 7, such as the three-dimensional contour data, the first optimized adjustment value, the second optimized adjustment value and the polishing and grinding quality, can be further stored in the database 14 and used in the next robot polishing and grinding process 15.

In sum, a method and a system for controlling polishing and grinding a work piece according to the present disclosure use machine learning to automatically update and generate an optimized polishing and grinding trajectory. In an embodiment, a portion of contours of a variety of work pieces and optimal polishing and grinding trajectories corresponding to the portion of the contours are stored in a database. Therefore, as a plurality of work pieces to be polished and ground have different shapes, corresponding polishing and grinding trajectories of the work pieces can be generated automatically. The problem of the prior art that the conventional polishing and grinding apparatus cannot automatically adjust polishing and grinding trajectories to maintain the best quality can thus be solved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for controlling polishing and grinding, applicable to a robot clamping a work piece to be polished or ground, the method comprising the following steps of:
(1) generating an initial polishing and grinding trajectory for robot movements based on a three-dimensional contour of the work piece stored in a database;
(2) adjusting the initial polishing and grinding trajectory based on a first optimized adjustment value stored in the database for polishing and grinding the work piece; and
(3) evaluating if polishing and grinding quality of the work piece is better than polishing and grinding quality of a last work piece, and, if so, generating a second optimized adjustment value in place of the first optimized adjustment value, or returning to step (2).

2. The method of claim 1, further comprising replacing a polishing and grinding force of the work piece for a polishing and grinding force of the last work piece when the polishing and grinding quality of the work piece is better than the polishing and grinding quality of the last work piece.

3. The method of claim 1, wherein the initial polishing and grinding trajectory for robot movements is a combination of polishing and grinding trajectories of a portion of contours of a plurality of work pieces that have been polished and ground previously.

4. The method of claim 1, further comprising determining quality of an abrasive belt of a polishing and grinding apparatus that is used for polishing and grinding the work piece based on the first optimized adjustment value, and indicating that surface roughness of the abrasive belt is less than a predetermined value when the first optimized adjustment value is greater than a threshold.

5. The method of claim 4, wherein the first optimized adjustment value and the second optimized adjustment value include a feed rate of the work piece moving along a normal direction of a surface of the abrasive belt when the work piece is in contact with the surface of the abrasive belt.

6. The method of claim 1, wherein step (2) comprises adjusting the initial polishing and grinding trajectory for robot movements based on a determination result of final polishing and grinding quality of the last work piece.

7. The method of claim 1, wherein step (2) comprises adjusting the initial polishing and grinding trajectory for robot movements based on the polishing and grinding quality of the work piece when being polished and ground.

8. The method of claim 1, wherein the polishing and grinding quality of the work piece is evaluated based on surface roughness of the work piece after being polished and ground.

9. The method of claim 1, wherein the polishing and grinding quality of the work piece is evaluated based on an audio frequency during a polishing and grinding process.

10. A system for controlling polishing and grinding, applicable to a robot clamping a work piece to be polished or ground, the system comprising:
a trajectory generating module configured for generating an initial polishing and grinding trajectory for robot movements based on a three-dimensional contour of the work piece;
a trajectory optimizing module configured for adjusting the initial polishing and grinding trajectory based on a first optimized adjustment value for polishing and grinding the work piece; and
a quality evaluating module configured for evaluating if polishing and grinding quality of the work piece is better than polishing and grinding quality of a last work piece, and, if so, generating a second optimized adjustment value in place of the first optimized adjustment value.

11. The system of claim 10, wherein the trajectory generating module generates the initial polishing and grinding trajectory for robot movements by combining polishing and grinding trajectories corresponding to a portion of contours of a plurality of polished and ground work pieces stored in a database.

12. The system of claim 10, wherein the quality evaluating module determines quality of an abrasive belt of a polishing and grinding apparatus that is used to polish and grind the work piece based on variation of the first optimized adjustment value, and indicates that surface roughness of the abrasive belt is less than a predetermined value when the first optimized adjustment value is greater than a threshold.

13. The system of claim 12, wherein the trajectory optimizing module further adjusts the initial polishing and grinding trajectory by adjusting a feed rate of the work piece moving along a normal direction of a surface of the abrasive belt when the work piece is in contact with the surface of the abrasive belt.

14. The system of claim 10, wherein the trajectory optimizing module adjusts the initial polishing and grinding trajectory for robot movements based on final polishing and grinding quality of the last work piece stored in a database.

15. The system of claim 10, wherein the trajectory optimizing module adjusts the initial polishing and grinding trajectory for robot movements based on the polishing and grinding quality of the work piece during a polishing and grinding process.

16. The system of claim 10, wherein the quality evaluating module determines the polishing and grinding quality of the work piece based on a measurement result of surface roughness of the work piece after being polished and ground measured by a surface roughness measuring apparatus.

17. The system of claim 10, wherein the quality evaluating module determines the polishing and grinding quality of the work piece based on an audio frequency detecting result of the polishing and grinding process of the work piece detected by an acoustic emission sensor.
